(19) United States
(12) Patent Application Publication
(10) Pub. No.: US 2012/0153919 A1
(43) Pub. Date: Jun. 21, 2012

(54) Switching Mode Power Supply Control

(76) Inventors: Cristian Garbossa, Bressanone (IT); Marco Flaibani, Padova (IT); Andrea Vecchiato, Mirano (IT); Enrico Orietti, Pozzonovo (IT)

(21) Appl. No.: 12/971,378

(22) Filed: Dec. 17, 2010

(51) Int. Cl. G05F 1/46

(52) U.S. Cl. 323/284

(57) ABSTRACT

A method for controlling a switching converter is disclosed whereby the switching converter is configured to convert an input voltage into an output voltage supplied to a load in accordance with a switching signal, The switching converter is configured to operate in a pulse width modulation mode or, alternatively, in a pulse frequency modulation mode. When operating in the pulse width modulation mode, generating, as the switching signal, a pulse width modulated (PWM) signal of a pre-defined constant switching frequency. The PWM signal has a duty cycle that is regulated such that the output voltage of the switching converter matches, at least approximately, a desired output voltage under the condition that the duty cycle being regulated such that it does not fall below a predefined minimum duty cycle. The output voltage is monitored and switched over to the pulse frequency modulation mode when the output voltage exceeds a predefined first threshold. The method further comprises, when operating in the pulse frequency modulation mode, monitoring the output voltage and generating, as the switching signal, a series of pulses of a predefined constant pulse length. A pulse is generated each time the output voltage falls to a predefined second threshold and monitoring the frequency of the switching signal and switching to the pulse width modulation mode when the frequency of the switching signal exceeds a predefined frequency threshold.

### TECHNICAL FIELD

The present disclosure relates to the switching control of a switched mode power supply (SMPS) for ensuring an efficient operation thereof, in particular SMPS including control modes using either a pulse width modulation or a pulse frequency modulation for generating switching signals.

### BACKGROUND

In recent years, stringent requirements concerning the efficiency of power supplies have brought attention to the use of Switching Mode Power Supplies (SMPS, also referred to as “switching converters”). However, the actual efficiency of an SMPS depends on the controller that determines the switching instants of the semiconductor switch(es) included in the SMPS. Probably the most common approach for controlling the switching of an SMPS is Pulse Width Modulation (PWM) which can implemented quite easily. However, using PWM for controlling an SMPS and thus for regulating its output voltage or output current does not guarantee a high efficiency over a wide range of output currents.

A PWM based controller unit operates at a fixed frequency (PWM frequency), while modulating the duty-cycle of a rectangular PWM signal in order to regulate the power-supply output voltage (or current). The efficiency of power converters rapidly decreases at low output currents as driving losses remain constant (i.e., those losses related to the switching on and switching off of the semiconductor switches used in the output stage of the switching converter). In order to decrease the contribution of driving losses to the total amount of losses (all remaining losses essentially depend on the output current and thus decrease as the output current decreases) a Pulse Frequency Modulation (PFM) may be used for controlling the semiconductor switch(es) included in the output stage of the switching converter.

A controller unit using PFM reduces the duty cycle by reducing the switching frequency while keeping the on-time constant instead of reducing the on-time at a constant frequency as it is done when using PWM control. However, the efficiency of PFM control is increasingly bad at high output currents as the switching frequency (and thus switching and driving losses) increase as the output current increases.

A consolidated view of the above leads to the conclusion that PWM control is more efficient (than PFM control) at high output currents and PFM control is more efficient at low output currents. Controller units for the use in SMPS have been proposed that include both a PFM controller unit and a PWM controller unit so as to benefit by the advantages of both types of control of the SMPS. However, the complexity of the implementation of such PWM/PFM controlled switching converters is undesirably high and require additional hardware for determining the conditions defining the switchover from PWM mode to PFM mode (and vice versa). Further, some implementations may lead to an undesirable toggling between the two control modes.

There remains a need for switching converters using a control that allows for an improved efficiency throughout a wide range of output currents.

### SUMMARY OF THE INVENTION

One embodiment of the present invention relates to a method for controlling a switching converter that is configured to convert an input voltage into an output voltage supplied to a load in accordance with a switching signal. The switching converter is configured to operate in a pulse width modulation mode or, alternatively, in a pulse frequency modulation mode. The method comprises, when operating in the pulse width modulation mode: generating, as the switching signal, a pulse width modulated (PWM) signal of a pre-defined constant switching frequency. The PWM signal has a duty cycle that is regulated such that the output voltage of the switching converter matches, at least approximately, a desired output voltage under the condition that the duty cycle is regulated such that it does not fall below a predefined minimum duty cycle. The output voltage is monitored and switched over to the pulse frequency modulation mode when the output voltage exceeds a predefined first threshold. The method further comprises, when operating in the pulse frequency modulation mode, monitoring the output voltage and generating, as the switching signal, a series of pulses of a predefined constant pulse length. A pulse is generated each time the output voltage falls to a predefined second threshold. The frequency of the switching signal is monitored and switched to the pulse width modulation mode when the frequency of the switching signal exceeds a predefined frequency threshold.

One embodiment of the present invention relates to a controller circuit for controlling a switching converter which is configured to convert an input voltage into an output voltage supplied to a load in accordance with a switching signal. The controller circuit and thus the switching converter are configured to operate in a pulse width modulation mode or, alternatively, in a pulse frequency modulation mode. When operating in the pulse width modulation mode, the controller circuit is configured to generate, as the switching signal, a pulse width modulated (PWM) signal of a pre-defined constant switching frequency. The PWM signal has a duty cycle that is regulated such that the output voltage of the switching converter matches, at least approximately, a desired output voltage under the condition that the duty cycle is regulated such that it does not fall below a predefined minimum duty cycle. In the pulse width modulation mode, the controller circuit is further configured to monitor the output voltage and to switch over to the pulse frequency modulation mode when the output voltage exceeds a predefined first threshold. When operating in the pulse frequency modulation mode, the controller circuit is configured to monitor the output voltage and to generate, as the switching signal, a series of pulses of a predefined constant pulse length. A pulse is generated each time the output voltage falls to a predefined second threshold. In the pulse frequency modulation mode, the controller circuit is further configured to monitor the frequency of the switching signal and to switch to the pulse width modulation mode when the frequency of the switching signal exceeds a predefined frequency threshold.

### BRIEF DESCRIPTION OF THE DRAWINGS

The invention can be better understood with reference to the following drawings and description. The components in the figures are not necessarily to scale, instead emphasis being placed upon illustrating the principles of the invention. Moreover, in the figures, like reference numerals designate corresponding parts. In the drawings:

FIG. 1a and 1b, collectively FIG. 1, shows a schematic diagrams illustrating a standard switching converter (FIG. 1a) and a respective controller circuit (FIG. 1b) which may be included in a SMPS;

FIG. 2 is a diagram illustrating the efficiency of power conversion by a switching converter for switching controllers using pulse width modulation (PWM) and pulse frequency modulation (PFM);

FIG. 3 is a diagram illustrating the conditions for changing from PWM control to PFM control and vice versa whereby, in the illustrated example, in both control modes the switching signal exhibits the same minimum on time;

FIG. 4 includes timing diagrams illustrating the output current, the switching signal and the output voltage over time when changing from PWM control to PFM control;

FIG. 5 includes timing diagrams illustrating the output current, the switching signal and the output voltage over time when changing from PFM control to PWFM control;

FIG. 6 is a schematic diagram illustrating one exemplary embodiment of a combined PWM/PFM switching controller;

FIG. 7 is a schematic diagram of an alternative PFM loop controller to the PFM loop controller of FIG. 6 allowing for a PFM frequency clamping during PFM control mode; and

FIG. 8 illustrates the concept frequency clamping during PFM control mode by means of a timing diagram.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

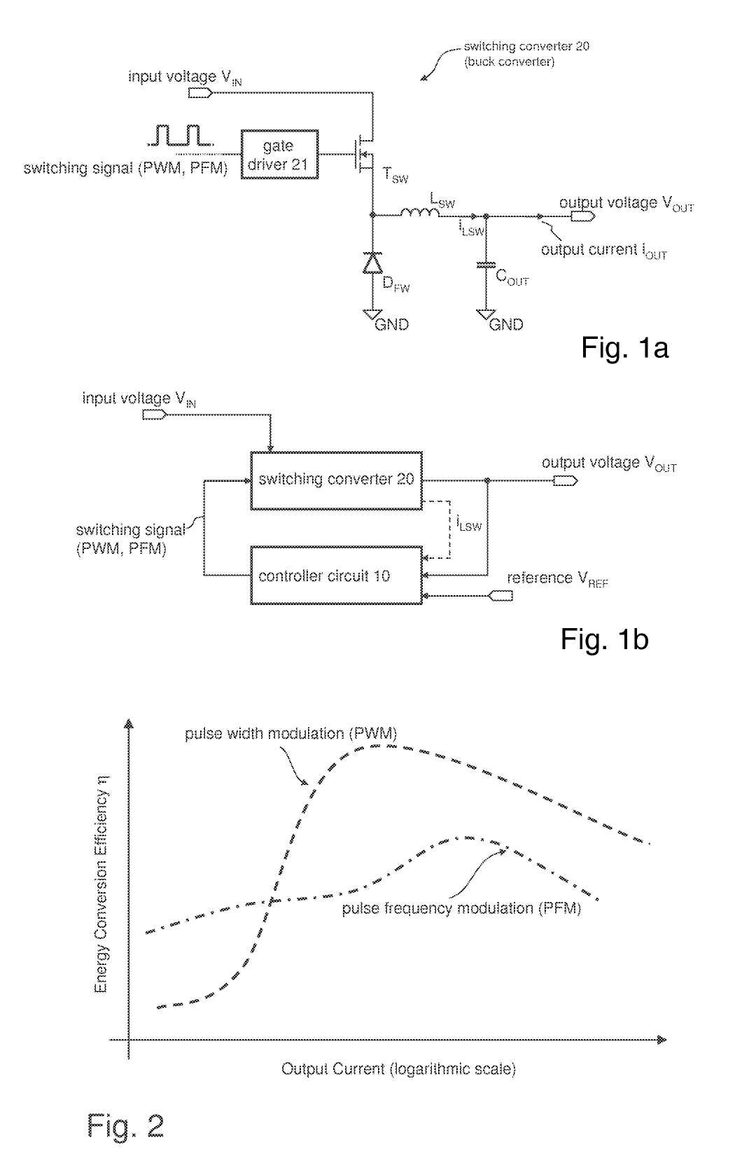

FIG. 1 a illustrates the topology of a common buck converter as one example of a switching converter. However, it should be noted that the present invention is not limited to switched mode power supplies (SMPS) including buck converters. The inventive concepts may be readily applied to any type of switching converter such as boost converters, buck-boost converters, Ćuk converters, flyback converters, etc. Generally a switching converter includes at least one switching element which are, in the present example of FIG. 1, a MOS transistor T_{SW} and a free-wheeling diode D_{FW}. Further, switching converters typically include at least one inductor which is inductor L_{SW} in the example of FIG. 1. An output capacitor C_{OUT} may be provided as a decoupling capacitor. Such a capacitor may be necessary or not dependent on the load (not shown in FIG. 1) which is connected to the switching converter output. At least one of the switching elements (in the example of FIG. 1 only MOS transistor T_{SW}) may be driven on and off in accordance with a driver signal which may be generated by a gate driver circuit 21 in response to a respective switching signal (e.g., a PWM or a PFM signal) supplied to the gate driver circuit 21.

For most types of switching converters the output voltage V_{OUT} of the converter 20 depends on the ratio between the average on time and the average off time of the switching element, e.g., of the MOS transistor T_{SW}. In the context of a pulse width modulated switching signal this ratio is typically represented by the duty cycle which can be seen as an average relative on time (typically given as percentage). However, a duty cycle value can be assigned to any periodic rectangular switching signal regardless of the type of modulation.

In order to provide a regulated output voltage V_{OUT} a controller circuit 10 (see FIG. 1b) is usually employed which includes a feedback circuit that is configured to generate an appropriate switching signal (e.g., a PWM signal or a PFM signal) depending on the actual output voltage V_{OUT} and a reference signal. For example, commonly known PWM controller circuits regulate the duty cycle of a PWM switching signal such that the difference between the reference signal and the actual output voltage V_{OUT} approximates zero. Additionally, the actual inductor current i_{LSW} may also be considered for generating the switching signal in the case of a more sophisticated control loop that additionally makes use of current information.

As already mentioned a PWM controlled power conversion is more efficient (than a PFM controlled) at high output currents and PFM controlled power conversion is more efficient at low output currents. This fact is illustrated in the diagram of FIG. 2 including the efficiency of power conversion for both, PWM controlled and PFM controlled. The dashed line illustrates the efficiency versus switching converter output current when using a PWM controller, whereas the dash-dotted line illustrates the efficiency versus switching converter output current when using a PFM controller. For output current values to the left of the point of intersection of the two lines PFM control is more efficient, whereas for output current values to the right of the point of intersection of the two lines PWM control performs better.

For the reason outlined above, controller units for the use in SMPS have been proposed that include both, a PFM controller unit and a PWM controller unit so as to benefit from the advantages of both types of control of the switching converter. However, the complexity of the implementation of such PWM/PFM controlled switching converters is undesirably high and requires additional hardware for determining the conditions defining the switchover from PWM mode to PFM mode (and vice versa). Further, some implementations may tend to an undesirable toggling between the two control modes.

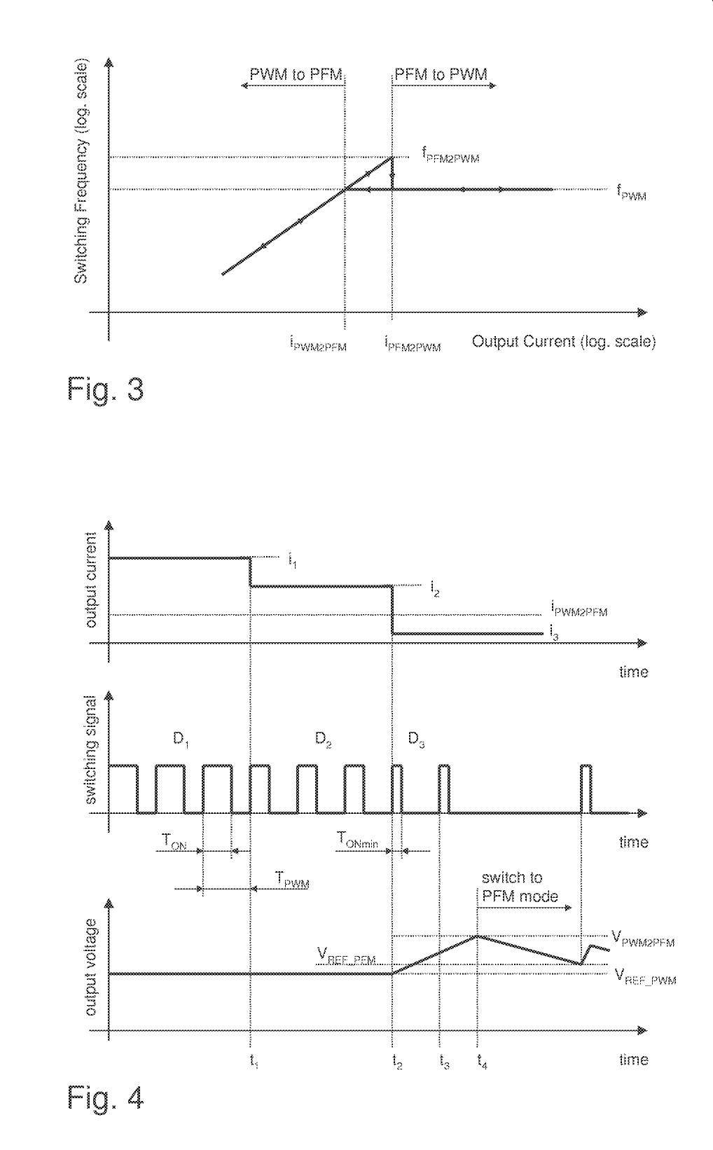

FIG. 3 is a diagram illustrating the conditions for the transition from PWM control to PFM control (and vice versa). These conditions can be detected in various embodiments of the present invention to determine when to switch from a PWM control mode to a PFM control mode and back to PWM control mode. In accordance with the example illustrated in FIG. 3 the transition from PWM control to PFM control takes place smoothly when the switching converter output current falls below a predefined current threshold i_{PWM2PFM}. The transition from PFM control to PWM control takes place when the (variable) switching frequency f_{PFM} in the PFM control mode exceeds a predefined frequency threshold f_{PFM2PWM}. In order to avoid an undesired toggling the predefined frequency threshold f_{PFM2PWM} is chosen such that the corresponding output current i_{PFM2PWM} is higher than the above mentioned current threshold i_{PWM2PFM}. Thus, a small hysteresis is achieved and toggling is avoided.

It should be noticed that from simple calculations which consider the converter topology (buck converter, boost converter, etc.) such current thresholds can be analytically evaluated using the known values of the converter filter components (inductor LSW, capacitor C_{OUT}, etc.) and operating voltages (V_{IN}, V_{OUT}). In the case of a buck converter, for example, the following formulas can be found demonstrating the ability of the proposed approach to guarantee by design a fixed and defined hysteresis with respect to the current thresholds, whereby the current threshold i_{PFM2PWM} is directly proportional to the frequency f_{PFM2PWM} chosen as threshold.

Assuming that the switching signals exhibit the same on time T_{ONmin} for PWM operation and PFM operation the following formulas can be derived:

$${i}_{PWM 2 PFM} = {t}_{ON\_min}^{2} \frac{{V}_{IN} - {V}_{0 UT}}{2 L} \frac{{V}_{IN}}{{V}_{0 UT}} {f}_{PWM}$$

$$\begin{matrix}{i}_{PFM 2 PWM} = {t}_{ON\_min}^{2} \frac{{V}_{IN} - {V}_{0 UT}}{2 L} \frac{{V}_{IN}}{{V}_{0 UT}} {f}_{PFM 2 PWM} \\ = {t}_{ON\_min}^{2} \frac{{V}_{IN} - {V}_{0 UT}}{2 L} \frac{{V}_{IN}}{{V}_{0 UT}} {f}_{PWM} ( 1 + Δ {F}_{\%} ) \\ = {i}_{PWM 2 PFM} ( 1 + Δ {F}_{\%} )\end{matrix}$$

demonstrating that the hysteresis with respect to the current thresholds can be managed by the ratio f_{PFM2PWM} over f_{PWM}.

In the case of different on times during the two control modes (T_{ONmin-PWM} during PWM control and T_{ONmin-PFM} during PFM control) the current thresholds can be calculated as:

$${i}_{PWM 2 PFM} = {t}_{ON\_min - PWM}^{2} \frac{{V}_{IN} - {V}_{0 UT}}{2 L} \frac{{V}_{IN}}{{V}_{0 UT}} {f}_{PWM}$$

$${i}_{PFM 2 PWM} = {t}_{ON\_min - PFM}^{2} \frac{{V}_{IN} - {V}_{0 UT}}{2 L} \frac{{V}_{IN}}{{V}_{0 UT}} {f}_{PFM 2 PWM} .$$

Consequently, the inequality

$$\frac{{i}_{PFM 2 PWM}}{{i}_{PWM 2 PFM}} = \frac{{t}_{ON\_min - PFM}^{2}}{{t}_{ON\_min - PWM}^{2}} \frac{{f}_{PFM 2 PWM}}{{f}_{PWM}} > 1$$

can be maintained with even less of a strict constraint on the PFM-to-PWM frequency threshold f_{PFM2PWM}. The frequency threshold f_{PFM2PWM} can be also lower than the PWM frequency f_{PWM} if a larger on time T_{ONmin-PFM} is chosen in PFM control mode as compared to PWM control mode. This results in a small improvement of efficiency during PFM control mode, as it is possible to reduce the switching frequency (without compromising the hysteresis) and therefore the driving and switching losses.

Summarizing the above conditions for the transition from PWM control mode PFM control mode and vice versa is:

condition 1: i_{OUT} < i_{PWM2PFM} → switch to PFM control mode
condition 2: i_{OUT} > i_{PFM2PWM} → switch to PWM control mode.

The second condition “condition 2” is equivalent to

condition 2a: f_{PFM} > f_{PPM2PWM} → switch to PWM control mode.

Detecting whether the output current i_{OUT} has fallen below the current threshold i_{PWM2PFM} would entail an undesirably complex detection circuit. In order to simplify matters it has been found that the evaluation of “condition 1” can be substituted by the evaluation of an equivalent “condition 1a” which simply requires comparing the output voltage V_{OUT} with a voltage reference V_{PWM2PFM}. For this purpose, in PWM control mode, the controller circuit is configured to prevent the duty cycle of the switching signal PWM from falling below a minimum duty cycle D_{MIN} corresponding to a minimum on time t_{ONmin} and also corresponding to the current threshold i_{PWM2PFM}. Assuming PWM control mode and a falling output current i_{OUT}, the duty cycle of the switching signal has to decrease in accordance with the output current i_{OUT} so as to keep the output voltage V_{OUT} at the desired constant level. When the output current i_{OUT} reaches the current threshold i_{PWM2PFM} the duty cycle simultaneously reaches the minimum duty cycle D_{MIN}. When the output current i_{OUT} falls below the current threshold i_{PWM2PFM} the duty cycle can not be further reduced and thus the output voltage V_{OUT} will start to increase which can be detected easily. Consequently “condition 1” can be substituted by the equivalent “condition 1a”, namely

condition 1a: V_{OUT} > V_{PWM2PFM} → switch to PFM control mode.

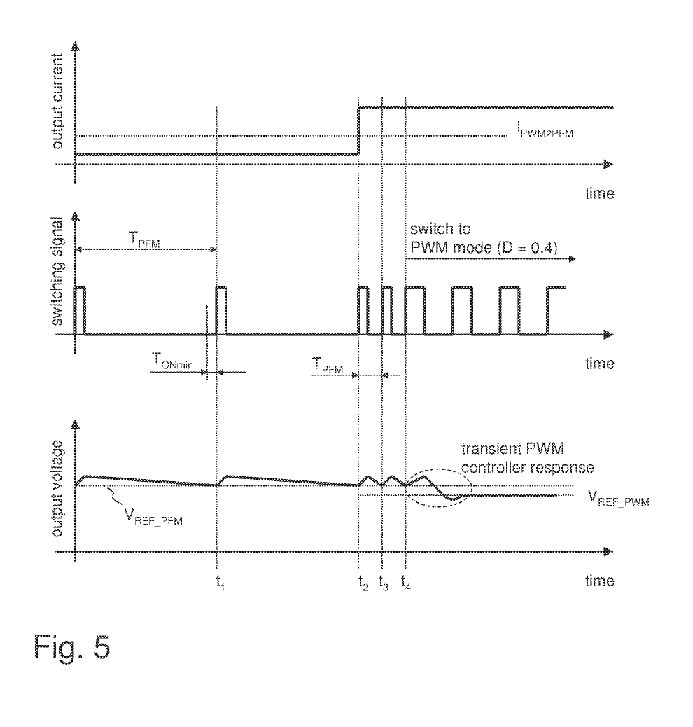

In accordance with embodiments of the present invention, “condition 1a” and “condition 2a” are evaluated for deciding whether to switch over to PFM control mode or PWM control mode. The resulting behavior of the controller circuit 10 is illustrated in FIGS. 4 and 5 and discussed in the following paragraphs.

FIG. 4 illustrates by means of timing diagrams illustrating the switching converter output current i_{OUT} over time, as well as the resulting switching signal and the output current V_{OUT}. In the example presented in FIG. 4 the switching signal initially is a PWM signal. After a drop of the output current i_{OUT} (at time instant t₂) the control mode is switched, and the switching signal henceforth is a PFM signal.

It is assumed that the controller circuit 10 is initially in a PWM control mode. Before time t₁ the output current i_{OUT} is equal to i₁ and large enough to ensure continuous conduction mode (CCM) of the switching converter. Thus the controller circuit generates, as a switching signal, a PWM signal with a duty cycle D₁ appropriate to regulate the output voltage to stay at its desired level V_{REF}_{_{—}}_{PWM}. At time instant tᵢ the load suddenly decreases and, as a result, the output current drops to a current i₂ thereby forcing the power supply to operate in discontinuous conduction mode (DCM). Thus, the controller circuit 10 reacts to the output current drop by further reducing the duty cycle of the (PWM) switching signal to D₂ in order to keep the output voltage V_{OUT} at its desired level V_{REF}_{_{—}}_{PWM}. At time instant t₂ the load further decreases and, again as a result, the output current i_{OUT} drops to a current i₃. As mentioned above the duty cycle can not fall below a minimum duty cycle D_{MIN} due to an appropriate circuit design. In the present example the minimum duty cycle has been set to D_{MIN}=0.2 and thus the switching signal exhibits pulses of a minimum on time T_{ONmin}. Consequently, the controller circuit 10 is not further able to regulate the output voltage V_{OUT} so as to match the desired voltage level V_{REF}_{_{—}}_{PWM} and the output voltage starts to rise above the desired voltage level V_{REF}_{_{—}}_{PWM} while the controller circuit continues operating a the PWM frequency f_{PMW}=T_{PWM}⁻¹. The rise of the output voltage can be detected easily using a comparator which is triggered (see time instant t₄ in FIG. 4) when the output voltage V_{OUT} reaches a threshold voltage V_{PWM2PFM}. Dependent on the actual application the rise of the output voltage may be detected within one single PWM cycle or within a plurality of cycles. The triggering of the comparator initiates a control mode switch from PWM control to PFM control. During the PFM control mode the controller circuit 10 generates, as a switching signal, a series of pulses of a predefined constant pulse length (which may or may not correspond to the minimum on time T_{ONmin}), whereby a pulse is generated each time the output voltage V_{OUT} falls to (or below) a predefined threshold V_{REF}_{_{—}}_{PFM} which is lower than or equal to the threshold V_{PWM2PFM}. With each pulse the output voltage V_{OUT} will, again, slightly rise above the threshold voltage V_{REF PFM} and then decay again to the threshold voltage V_{REF PFM} thereby causing a small (but tolerable) ripple. Such PFM control behavior is considerably easier to implement which makes up for the small ripple which can be neglected in most applications. During PFM control mode the pulses will repeat with a (output current dependent) frequency f_{PFM}=T_{PFM}⁻¹. As mentioned above, the voltage threshold V_{PWM2PFM} corresponds to a respective current threshold i_{PWM2PFM} (see FIG. 3).

The example of FIG. 5 illustrates, again by means of timing diagrams, the reverse control mode change, namely the switch over from PFM control mode to PWM control mode after a sudden upward step (see time instant t₂ in FIG. 5) of the switching converter output current i_{OUT}. In PFM control mode the controller circuit will respond to the increased output current i_{OUT} by increasing the repetition rate of the pulses which compose the switching signal, i.e., by increasing the PFM frequency f_{PFM}. When the PFM frequency f_{PFM} reaches (or exceeds) a frequency threshold f_{PFM2PWM} then a control mode switch from PFM control mode back to PWM control mode is initiated (see time instant t₄ in FIG. 5). It should be noted that the frequency threshold f_{PFM2PWM} corresponds to a respective current threshold i_{PFM2PWM} (see FIG. 3). When switching from PFM control mode to PWM control mode a transient output voltage swing may be observed which is a result of the finite settling time T_{S} of the voltage control in PWM control mode. After the settling time T_{S} the output voltage is regulated in a usual manner so as to match the desired voltage level V_{REF}_{_{—}}_{PWM} as mentioned above with respect to FIG. 4.

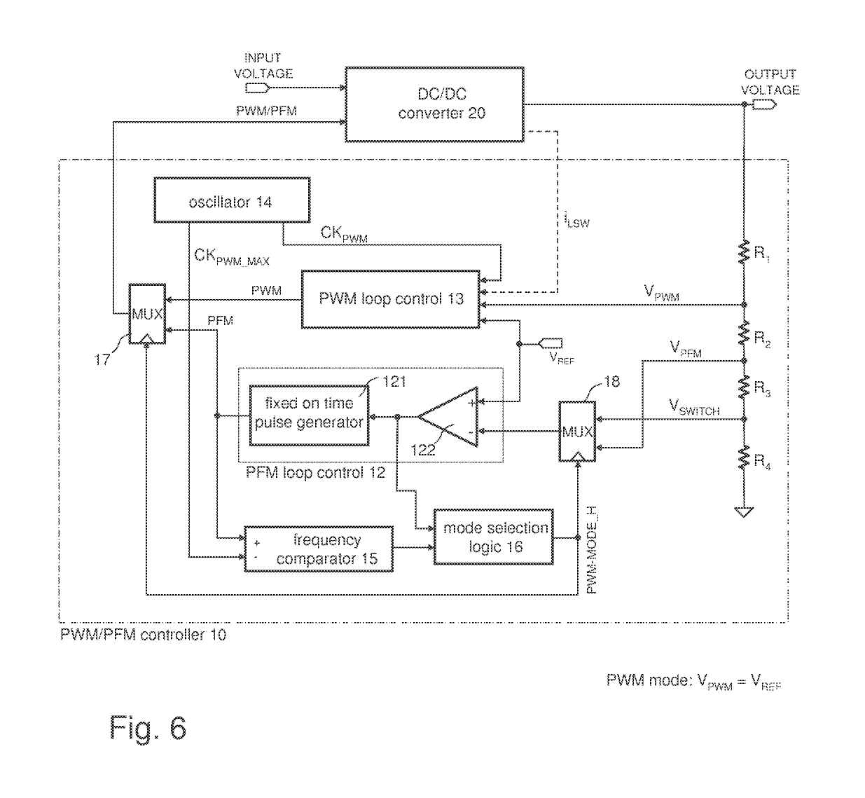

Having described the function(s) of embodiments of the present invention an exemplary controller circuit 10 configured to perform this function(s) is illustrated in FIG. 6. However, it should be clear that many of the circuit components (or a set of components) may be replaced by alternative circuitry performing an equivalent function. Finally, it has to be understood that the same function may be achieved using a fully digital implementation. In essence, FIG. 6 illustrates the switched mode power supply of FIG. 1b with one exemplary controller circuit 10 being depicted in more detail.

Instead of comparing the output voltage V_{OUT} with different voltage thresholds V_{PWM2PFM}, V_{REF}_{—}_{PWM}, and V_{REF}_{—}_{PFM} as discussed above, in the present embodiment only one reference voltage V_{REF} is compared to different fractionals of the output voltage V_{OUT} which leads to equivalent results. The fractionals of the output voltage V_{OUT} may be tapped from a voltage divider including the resistors R₁, R₂, R₃, and R₄ connected between a reference potential (e.g., ground) and the output of the switching converter 20. In the present example the following equations apply:

V_{SWITCH}=V_{OUT}R₄/R_{SUM},

V_{PFM}=V_{OUT}(R₃+R₄)/R_{SUM},

V_{PWM}=V_{OUT}(R₂+R₃+R₄)/R_{SUM},

wherein R_{SUM}=R₁+R₂+R₃+R₄. Thus the above mentioned “condition 1a” (V_{OUT}>V_{PWM2PFM}) may be replaced by V_{OUT}R₄/R_{SUM}>V_{REF} which is equivalent to V_{OUT}>V_{REF}·R_{SUM}/R₄. Therefrom it follows that the above-mentioned threshold V_{PWM2PFM} equals V_{REF}·R_{SUM}/R₄ in the present example. Analogously, the threshold V_{PWM}_{—}_{REF} equals V_{REF}·R_{SUM}/(R₂+R₃+R₄) and the threshold V_{PFM}_{_{—}}_{REF} equals V_{REF}·R_{SUM}/(R₃+R₄).

The controller unit 10 illustrated in FIG. 6 includes, inter alia, a PWM loop controller 13, a PFM loop controller 12 and an oscillator 14. The PWM loop controller 13 may be of any common switching converter controller type such as a voltage mode controller (VMC) or a current mode controller (CMC). However, the PWM loop controller 13 is configured to ensure that the actual duty cycle of the PWM signal does not fall below a predefined minimum duty cycle, i.e., the on time of the pulses present in the PWM signal is not lower than a minimum on time T_{Onmin} as already mentioned above. As input signals the PWM loop controller 13 receives the reference voltage V_{REF}, the voltage signal V_{PWM}, which is a fraction of the output voltage V_{OUT}, the clock signal CK_{PWM} provided by the oscillator 14, and, optionally, a current sense signal representing the inductor current I_{LSW}. As output signal the PWM loop controller 13 provides a pulse width modulated switching signal which (when operating in PWM control mode) is supplied to the switching converter 20 via the multiplexer 17.

As already explained above with respect to FIG. 4 the output voltage V_{OUT} will start to rise when the output current falls below a current threshold i_{PWM2PFM} in PWM control mode. This rise of the output voltage V_{OUT} is detected by a comparator 122 which may be a part of the PFM loop controller 12. For this purpose and when operating in PWM control mode, the comparator 122 is supplied (via multiplexer 18) with the fraction V_{SWITCH} of the output voltage as well as with the reference voltage V_{REF}. The fractional voltage V_{SWITCH} reaching the reference voltage V_{REF} is equivalent with the output voltage V_{OUT} reaching the threshold V_{PWM2PFM} as discussed above. When the comparator is triggered a mode change from PWM to PFM control mode is initiated by the mode selection logic 16 which switches the multiplexers 17 and 18 to forward the PFM switching signal and, respectively, the fraction V_{PFM} of the output voltage. Further, the PWM loop controller 13 and the major part of the other controller circuitry may be powered down to a stand-by mode when the controller circuit 10 operates in PFM control mode. Basically, only the comparator 122 and the frequency comparator 14 remain “awake”. This allows for a further significant reduction of losses during PFM control mode (i.e., at low output currents).

During PFM control mode the comparator 122 is triggered each time the fractional voltage V_{PFM} reaches the reference voltage V_{REF} which is equivalent with the output voltage V_{OUT} reaching the threshold V_{PFM}_{_{—}}_{REF} as discussed above (see also FIG. 4 or 5). Each time the comparator 122 is triggered a pulse of a defined length is triggered, the resulting sequence of pulses forming the PFM switching signal which is supplied to the switching converter 20 via multiplexer 17. During PFM control mode the switching frequency is monitored by the frequency comparator 15 which is triggered when the PFM frequency f_{PFM}=T_{PFM} reaches or exceeds a maximum frequency f_{PFM2PWM} which corresponds to a critical output current i_{PFM2PWM} (see FIG. 2) as discussed above. In this case the mode selection logic 16 initiates a switch over from PFM to PWM control mode and the inputs of the multiplexers 17 and 18 are switched and the PWM loop controller 13 takes over control again.

Where applicable the mode selection logic 16 has to “wake up” the PWM loop controller 13 when it has been sent so stand by mode before. To accelerate mode switch a second frequency threshold f_{WAKEUP} may be provided to the frequency comparator which is slightly lower than the threshold f_{PFM2PWM}. In this case, the mode selection logic 16 may be configured to wake up the PWM loop controller 13 when the PFM frequency f_{PFM} exceeds the threshold f_{WAKEUP} and to subsequently initiate the mode switch when the PFM frequency f_{PFM} actually reaches the threshold f_{PFM2PWM} (and the PWM loop controller 13 is back from stand by mode).

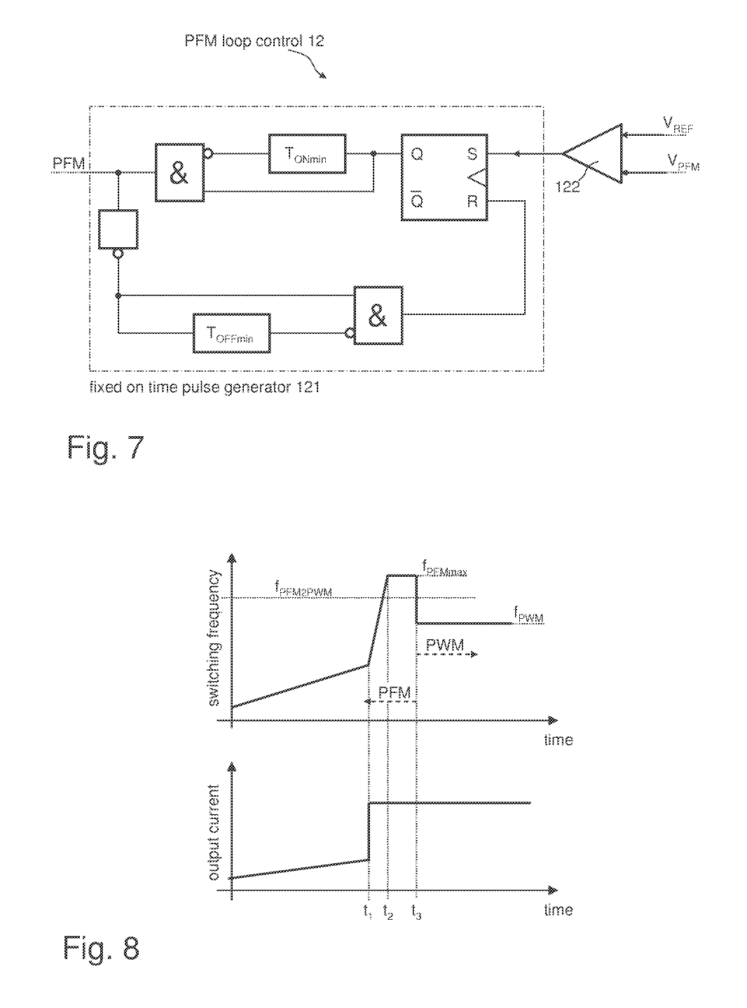

As the frequency comparator 15 (as well as other switching components) has limited reaction time the PFM frequency f_{PWM} can rise to frequency values significantly higher than the threshold f_{PFM2PWM}. Such limited reaction may be necessary to avoid spurious transitions from PFM to PWM control mode. In particular when the load increases very quickly (resulting in an upward step of the output current i_{OUT}) the PFM frequency f_{PFM} may rise to undesired high values in order to maintain the output voltage V_{OUT} at the desired level. Dependent on the actual implementation of the switching components it may be necessary to limit (to “clamp”) the PFM switching frequency f_{PFM} to a maximum frequency f_{PFMmax}. In order to achieve such a frequency clamping feature, the fixed on time pulse generator 121 included in the PFM loop controller 12 (see FIG. 6) needs to be slightly modified. An example of a fixed on time pulse generator 121 including frequency clamping functionality is illustrated in FIG. 7. The frequency clamping function is illustrated by means of timing diagrams in FIG. 8.

The fixed on time pulse generator 121 of the PFM controller of FIG. 7 includes an S/R latch which can be set by the comparator output 122. The output Q of the S/R latch is fed to a first AND gate as well as a delayed version of the output Q (delayed by a delay time T_{ONmin}). The output of the first AND gate will provide a pulse of the minimum on time T_{ONmin} when the pulse generator 121 is triggered by the comparator 122. However, at the end of the on pulse the S/R latch is blocked for a minimum off time T_{OFFmin}. The minimum off time T_{OFFmin} is, in the present example, achieved by driving the reset input R of the S/R latch low for a time period T_{OFFmin} after the end of the on pulse. For this purpose the pulse generator 121 includes an inverter, a further delay element providing a delay of T_{OFFmin} and a second AND gate whose output ties the reset input of the S/R latch to a low level for the time period T_{OFFmin}.

The function of the circuit of FIG. 7 is illustrated in the timing diagrams of FIG. 8. The bottom diagram illustrates the output current i_{OUT} over time. For the present example it is assumed that the switching converter initially operates in PFM control mode. Before time t₁ the output current i_{OUT} rises only slowly followed by a significant upward step at the time instant t₁. The top diagram illustrates the corresponding course of the PFM frequency. Before time t₁ The frequency rises as the output current rises, followed by a steep increase of the PFM frequency f_{PFM} resulting from the current step at time t₁. The PFM frequency f_{PFM} rises above the threshold f_{PFM2PWM} thereby initiating the transition to PWM control mode. Due to the limited reaction time of the frequency comparator 15 the PFM frequency f_{PFM} continues rising until it reaches (time instant t₂ in FIG. 7) the maximum PFM frequency f_{PFMmax}. The PFM frequency f_{PFM} remains then clamped to the maximum frequency f_{PFMmax} until the PWM loop controller 13 (see FIG. 6) takes over control at time t₃. Of course the output voltage V_{OUT} may deviate from the desired reference voltage during frequency clamping (i.e., between time t₂ and t₃). However, such transient deviation is uncritical in most applications. Additionally the frequency clamping entails the advantages that the frequency remains suitable for a correctly driving the semiconductor switches (see switch T_{SW} in FIG. 1), further it also acts as an over-current protection during the PFM control mode.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. It should be mentioned that features explained with reference to a specific figure may be combined with features of other figures, even in those not explicitly mentioned. Further, the methods of the invention may be achieved in either all software implementations, using the appropriate processor instructions, or in hybrid implementations that utilize a combination of hardware logic and software logic to achieve the same results. Such modifications to the inventive concept are intended to be covered by the appended claims.

What is claimed is:

1. A method for controlling a switching converter that is configured to convert an input voltage into an output voltage supplied to a load in accordance with a switching signal, the switching converter being configured to operate in a pulse width modulation mode or, alternatively, in a pulse frequency modulation mode, the method comprising:
when operating in the pulse width modulation mode:
generating, as the switching signal, a pulse width modulated (PWM) signal of a pre-defined constant switching frequency, the PWM signal having a duty cycle that is regulated such that the output voltage of the switching converter at least approximately matches a desired output voltage provided that the duty cycle does not fall below a predefined minimum duty cycle; and
monitoring the output voltage and switching over to the pulse frequency modulation mode when the output voltage exceeds a predefined first threshold; and
when operating in the pulse frequency modulation mode:
monitoring the output voltage and generating, as the switching signal, a series of pulses of a predefined constant pulse length, a pulse being generated each time the output voltage falls to a predefined second threshold; and
monitoring the frequency of the switching signal and switching to the pulse width modulation mode when the frequency of the switching signal exceeds a predefined first frequency threshold.

2. The method of claim 1, wherein the switching over to the pulse frequency modulation mode comprises:
powering down circuit components not required during the pulse frequency modulation mode into a low power consumption mode; and
wherein switching over to the pulse width modulation mode comprises:
recovering the circuit components from the low power consumption mode when the frequency of the switching signal exceeds a predefined second frequency threshold being lower or equal to the first frequency threshold.

3. The method of claim 1, wherein the predefined second threshold is higher than or equal to the desired output voltage during pulse width modulation mode.

4. The method of claim 1, wherein the predefined second threshold is lower than or equal to the first threshold.

5. The method of claim 1, wherein during pulse frequency modulation mode, the frequency of the switching signal is limited so as not to exceed a maximum switching frequency.

6. The method of claim 5, wherein limiting the frequency comprises:
ensuring, between each pulse of the series of pulses of a predefined constant pulse length, a minimum predefined off time.

7. The method of claim 1, wherein the switching converter comprises a buck converter or a boost converter or a buck-boost converter or a Cuk converter or a SEPIC converter (single ended primary inductance converter).

8. A controller circuit for controlling a switching converter that is configured to convert an input voltage into an output voltage supplied to a load in accordance with a switching signal, the controller circuit being configured to operate in a pulse width modulation mode or, alternatively, in a pulse frequency modulation mode;
wherein, when operating in the pulse width modulation mode, the controller circuit is configured
to generate, as the switching signal, a pulse width modulated (PWM) signal of a pre-defined constant switching frequency, the PWM signal having a duty cycle that is regulated such that the output voltage of the switching converter matches, at least approximately, a desired output voltage under the condition that the duty cycle being regulated such that it does not fall below a predefined minimum duty cycle; and
to monitor the output voltage and to switch over to the pulse frequency modulation mode when the output voltage exceeds a predefined first threshold; and
wherein, when operating in the pulse frequency modulation mode, the controller circuit is configured
to monitor the output voltage and to generate, as the switching signal, a series of pulses of a predefined constant pulse length, a pulse being generated each time the output voltage falls to a predefined second threshold; and
to monitor the frequency of the switching signal and to switch to the pulse width modulation mode when the frequency of the switching signal exceeds a predefined first frequency threshold.

9. The controller circuit of claim 8, further comprising:
a mode selection logic circuit configured to initiate switch-over to the pulse width modulation mode when the frequency of the switching signal exceeds a predefined first frequency threshold.

10. The controller circuit of claim 8, wherein the mode selection logic circuit is further configured to initiate switch-over the pulse frequency modulation mode when the output voltage exceeds a predefined first threshold.

11. The controller circuit of claim 10, further comprising:
a frequency comparator configured to monitor the frequency of the switching signal and to signal to the mode selection logic circuit when the frequency of the switching signal exceeds the first frequency threshold.

12. The controller circuit of claim 11, further comprising a comparator receiving a reference signal and a first signal representative of the output voltage, and configured to signal to the mode selection logic circuit when the first signal representative of the output voltage exceeds the reference signal.

13. The controller circuit of claim 10, further comprising:
a PWM loop controller configured to generate, during pulse width modulation mode, a pulse width modulated switching signal having a such a duty cycle that s second signal representative of the output voltage matches a reference signal.

14. The controller circuit of claim 10, further comprising:
a PFM loop controller that comprises a pulse generator configured to a series of pulses of a predefined constant pulse length, a pulse being generated each time the output voltage falls to the predefined second threshold.

15. The controller circuit of claim 14, wherein the PFM loop controller comprises a comparator receiving a third signal representative of the output voltage and the reference signal, and wherein the pulse generator is configured to generate a pulse each time the third signal representative of the output voltage is equal to or exceeds the reference signal.
